(19) United States
(12) Patent Application Publication
(10) Pub. No.: US 2008/0019530 A1
(43) Pub. Date: Jan. 24, 2008

(54) MESSAGE ARCHIVAL ASSURANCE FOR ENCRYPTED COMMUNICATIONS

(75) Inventors: Alan D. Eldridge, Hollis, NH (US); David S. Kern, Billerica, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/420,986

(22) Filed: May 30, 2006

(51) Int. Cl. H04L 9/00

(52) U.S. Cl. 380/286

(57) ABSTRACT

Embodiments of the present invention address deficiencies of the art in respect to encrypted message management in an archival environment, and provide a novel and non-obvious method, system and computer program product for message archival assurance. In one embodiment of the invention, a message archival assurance method can be provided that can include receiving an encrypted message designated for receipt by a messaging client; determining whether the encrypted message is decryptable using one of a set of a bulk keys accessible by the messaging system; and, archiving and forwarding the encrypted message to the messaging client only if the encrypted message is decryptable using one of a set of bulk keys accessible by the messaging system and otherwise discarding the encrypted message.

### BACKGROUND OF THE INVENTION

1. Field of the Invention

The present invention relates to the field of data encryption and more particularly to the organizational archiving of encrypted messages.

2. Description of the Related Art

Information technologists view network security to be a top priority in the deployment and management of information technology resources. While network security often involves such diverse aspects of the enterprise which range from routing gateways onto the public network to virus detection and remediation, securing the privacy and confidentiality of data remains a bedrock mission for the network security specialist. Generally, data security relates directly to the science of cryptography as applied to data of interest.

In cryptography, security can be achieved through encryption. Encryption involves the conversion of a clear-text message into a data stream that appears to be a meaningless and random sequence of bits known as cipher text. A cryptographic algorithm, also known as cipher, is the mathematical function that processes plain text input to produce a cipher text message. All modern ciphers use keys together with plain text as the input to produce cipher text. In this regard, a key is a value that works with a cryptographic algorithm to produce specific cipher text. The same or a different key can be supplied to the decryption function to recover plain text from cipher text.

There are a number of techniques used to encrypt and decrypt information with passwords. Generally, encryption and decryption approaches can be classified as symmetric and asymmetric in nature. The most common approach for symmetric encryption involves the one-way hashing of a known password. A pass-phrase hash is a method of transforming a text string that can be remembered by a human user, into a result that can be used either as an “authenticator”, which can be stored and used at a later time to check whether a user knows the pass-phrase, and as pseudorandom data for a cipher or secret key.

Securing the confidentiality of a message using encryption can be effective as between parties to a confidential exchange of information. So long as the parties to the confidential exchange can be identified or anticipated, a key exchange can be coordinated to permit the decryption of confidential information only for the benefit of authorized and intended recipients of the confidential information. Where a future recipient cannot be readily identified, however, coordinating access to the encrypted information can be challenging.

Specifically, within the enterprise, it can be important to preserve organizational records including messages. The preservation of organizational records in many cases serves the larger purpose of a future, unplanned audit to locate previously archived information. Of course, it is to be understood that a large portion of the previously archived information will include prior encrypted messages. Yet, without access to the relevant encryption keys, an auditor may not be able to access the content of a message so as to render the archival exercise ineffective.

### BRIEF SUMMARY OF THE INVENTION

Embodiments of the present invention address deficiencies of the art in respect to encrypted message management in an archival environment, and provide a novel and non-obvious method, system and computer program product for message archival assurance. In one embodiment of the invention, a message archival assurance method can be provided that can include receiving an encrypted message designated for receipt by a messaging client; determining whether the encrypted message is decryptable using one of a set of a bulk keys accessible by the messaging system; and, archiving and forwarding the encrypted message to the messaging client only if the encrypted message is decryptable using one of a set of bulk keys accessible by the messaging system and otherwise discarding the encrypted message.

In one aspect of the embodiment, the method also can include obtaining a key from the messaging client able to decrypt the encrypted message, adding the obtained key to a set of bulk keys for the messaging system, and archiving and forwarding the encrypted message to the messaging client, all when it is determined that the encrypted message is not decryptable using an archival key accessible by the messaging system. Furthermore, in another aspect of the embodiment, obtaining a key from the messaging client able to decrypt the encrypted message can include forwarding an encrypted set of bulk keys associated with the encrypted message to the messaging client, receiving a decrypted one of the set of bulk keys associated with the encrypted message from the messaging client; and, adding the decrypted one of the set of bulk keys to the bulk keys accessible by the messaging system.

Notably, receiving a decrypted one of the set of bulk keys associated with the encrypted message from the messaging client can include receiving a re-encrypted one of the set of bulk keys using a public form of an archival key for the messaging system, and decrypting the re-encrypted one of the set of bulk keys using a private form of the archival key for the messaging system. Thereafter, the method further can include decrypting the encrypted message to produce a decrypted message, and validating the decrypted message. By comparison, in a further aspect of the embodiment, obtaining a key from the messaging client able to decrypt the encrypted message can include receiving a selected bulk data key encrypted with a public form of an archival key for the messaging system and verifying that the encrypted selected bulk data key is marked as decryptable by a private form of the archival key for the messaging system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for message archival assurance for encrypted messages; and,

FIG. 2 is a flow chart illustrating a process for message archival assurance for encrypted messages.

### DETAILED DESCRIPTION OF THE INVENTION

Embodiments of the present invention provide a method, system and computer program product for message archival assurance for encrypted messages. In accordance with an embodiment of the present invention, encrypted messages received in a messaging system can be inspected to determine whether the encrypted messages can be decrypted through an archival key accessible in the messaging system. If so, the message can be forwarded to the designated recipient in the messaging system and archived accordingly. Otherwise, the messaging system can engage in encrypted message archival assurance in order to ensure that an archived form of the message can be accessed at a later time by a third party.

In the archival assurance process, a set of encrypted bulk data keys provided in association with the bulk data of the message can be passed to the client for further processing. Upon receipt of the encrypted bulk data keys, the client can decrypt the bulk data keys selecting one of the keys and can re-encrypt the selected key utilizing a public form of the archival key accessible in the messaging system. Thereafter, the client can return the re-encrypted key to the messaging system for use in processing the bulk data of the message.

Upon receipt of the re-encrypted key, the messaging system can decrypt the key and apply the new key to the bulk data of the message in order to decrypt the bulk data. Once the efficacy of the new key has been confirmed, the new key can be added to a list of bulk data keys for the message and the message in its encrypted form can be passed to the client and concurrently archived. In this way, the messaging system can be assured of the ability to access the bulk data of the encrypted message at a later time though the client as designated message recipient may no longer enjoy an active presence in the messaging system.

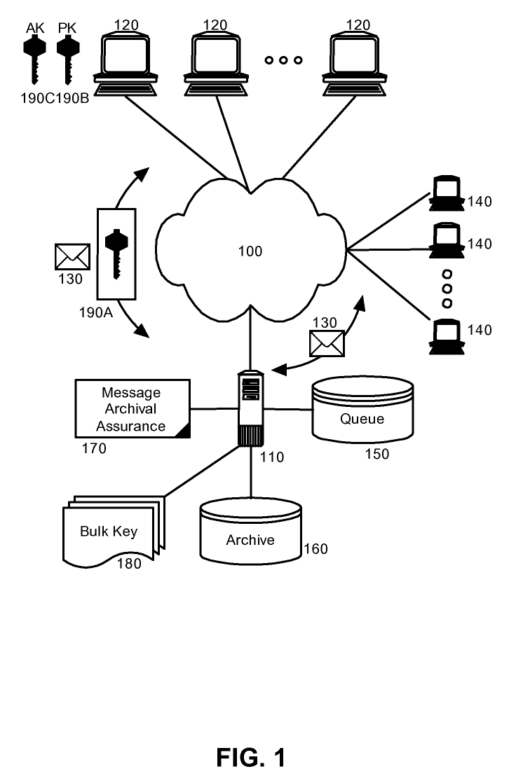

In illustration of an embodiment of the invention, FIG. 1 is a schematic illustration of a data processing system configured for message archival assurance for encrypted messages. The system can include a messaging system 110 configured to process and deliver messages to one or more communicatively coupled messaging clients 120 from one or more message sources 140 over a computer communications network 100. The messaging system 110 can include a message queue 150 in which inbound messages from message sources 140 can be stored prior to delivery to designated ones of the messaging clients 120. The messaging system 110 further can include an archive 160 into which received messages can be archived for subsequent access by third parties.

Notably, message archival assurance logic 170 can be coupled to the messaging system 110. The message archival assurance logic 170 can include program code enabled to process an inbound encrypted message 130 to ensure proper archiving within the archive 160 irrespective of the encryption key required to decrypt the message 130. In this regard, upon receipt of the encrypted message 130, the program code of the message archival assurance logic 170 can determine if an archival key already exists for the encrypted message 130 in the bulk data keys 180. If so, the message 130 can be routed to the designated one of the messaging clients 120 and archived in the archive 160. Otherwise, the program code of the message archival assurance logic 170 can further process the message 130 to ensure proper archiving of the message 130 within the archive 160.

Specifically, once determining that an archival key does not exist for the inbound encrypted message 130, a set of bulk data keys 190A provided in association with the encrypted message 130 can be passed to the designated one of the messaging clients 120. The designated one of the messaging clients 120 in turn can decrypt the bulk data keys 190A with private key 190B and can re-encrypt a selected one of the bulk data keys 190A with the public archival key 190C for the messaging system 110. Thereafter, the designated one of the messaging clients 120 can forward the encrypted form of the selected one of the bulk data keys 190A to the messaging server 110 which can decrypt the selected one of the bulk data keys 190A using the private form of the archival key.

Once the messaging server 110 has decrypted the selected one of the bulk data keys 190A using the private form of the archival key, the messaging server 110 can add the selected one of the bulk data keys 190A to the bulk keys 180 managed by the messaging server for accessing archived messages in the archive 160. Concurrently, the messaging server 110 can forward the inbound encrypted message 130 to the designated one of the messaging clients 120 and the messaging server 110 can store a copy of the inbound encrypted message 130 in the archive 160 with the assurance that a third party can access the archived copy of the encrypted message 130 using one of the bulk data keys 180.

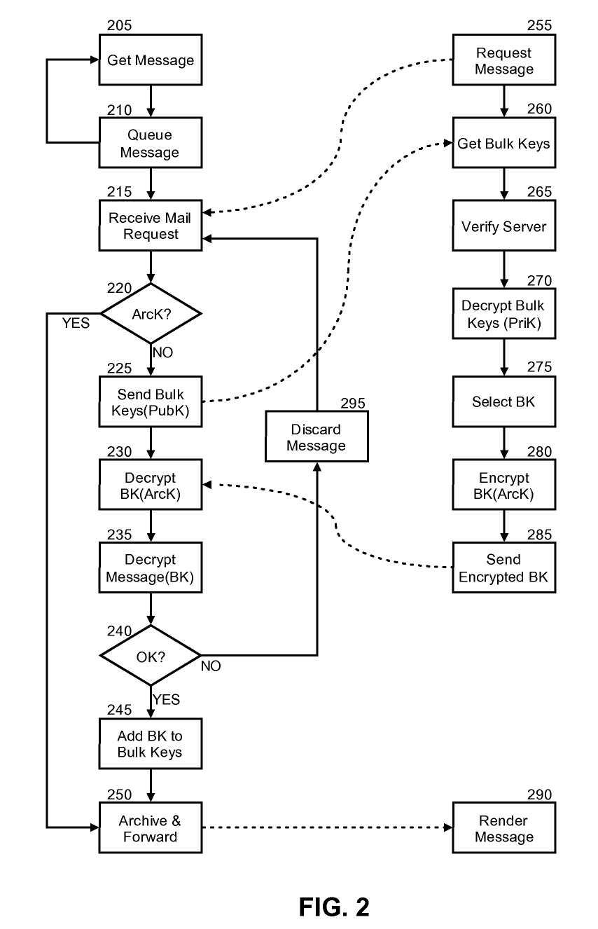

In yet further illustration, FIG. 2 is a flow chart illustrating a process for message archival assurance for encrypted messages. Beginning in block 205, an encrypted message can be received in the messaging system and in block 210, the encrypted message can be queued for processing by the archival assurance logic. In block 255, a messaging client can request the retrieval of the encrypted message and in block 215, the messaging system can receive the retrieval request. In decision block 220, if an archival key exists for the encrypted message such that the build data in the message can be decrypted using the archival key, then in block 250 the encrypted message can be archived and forwarded to the messaging client and in block 290, the messaging client can render the message.

In decision block 220, if an archival key does not exist for the encrypted message such that the build data in the message cannot be decrypted using the archival key, in block 225 a set of bulk data keys associated with the encrypted message can be forwarded to the messaging client in encrypted form (presumably having been encrypted with the public key of the messaging client). In block 260, the messaging client can receive the encrypted set of bulk data keys and in block 265, the messaging client can verify the identity of the server as a trusted message source.

In block 270 the bulk data keys can be decrypted using the private key of the messaging client and in block 275, a desired key can be selected for decrypting the bulk data of the message. Thereafter, in block 280 the selected key can be re-encrypted using the public archival key for the messaging server. Once re-encrypted, the selected bulk data key can be returned to the messaging server so that the messaging server can attempt to decrypt the selected bulk data key using a private form of the archival key in block 230. Once successful, in block 235 the messaging server can decrypt the bulk data of the message and verify the integrity of the decrypted message.

Notably, in the scenario where the messaging server is not configured with a private form of the archival key and only is configured with a public form of the archival key, the messaging server at least can confirm that it remains possible for the bulk data key to have been encrypted using a private form of the archival key. In this regard, using the public form of the archival key, the messaging server can determine if the encrypted bulk key has been marked as being decryptable by the archival key.

In any case, in decision block 240, if the bulk data of the message fails verification, the message can be discarded in block 295 and the messaging system can return to process the next mail request. Otherwise, in block 245 the decrypted bulk data key can be added to the bulk keys of the messaging server and in block 250, the encrypted message can be both archived for subsequent access and forwarded to the messaging client. Finally, in block 290 the messaging client can decrypt and render the message.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In a messaging system, a message archival assurance method comprising:
receiving an encrypted message designated for receipt by a messaging client;
determining whether the encrypted message is decryptable using one of a set of a bulk keys accessible by the messaging system; and,
archiving and forwarding the encrypted message to the messaging client only if the encrypted message is decryptable using one of a set of bulk keys accessible by the messaging system and otherwise discarding the encrypted message.

2. The method of claim 1, further comprising, responsive to determining that the encrypted message is not decryptable using an archival key accessible by the messaging system, obtaining a key from the messaging client able to decrypt the encrypted message, adding the obtained key to a set of bulk keys for the messaging system, and archiving and forwarding the encrypted message to the messaging client.

3. The method of claim 2, wherein obtaining a key from the messaging client able to decrypt the encrypted message, comprises:
forwarding an encrypted set of bulk keys associated with the encrypted message to the messaging client;
receiving a decrypted one of the set of bulk keys associated with the encrypted message from the messaging client; and,
adding the decrypted one of the set of bulk keys to the bulk keys accessible by the messaging system.

4. The method of claim 3, wherein receiving a decrypted one of the set of bulk keys associated with the encrypted message from the messaging client, comprises:
receiving a re-encrypted one of the set of bulk keys using a public form of an archival key for the messaging system; and,
decrypting the re-encrypted one of the set of bulk keys using a private form of the archival key for the messaging system.

5. The method of claim 4, further comprising:
decrypting the encrypted message to produce a decrypted message; and,
validating the decrypted message.

6. The method of claim 2, wherein obtaining a key from the messaging client able to decrypt the encrypted message, comprises:
receiving a selected bulk data key encrypted with a public form of an archival key for the messaging system; and,
verifying that the encrypted selected bulk data key is marked as decryptable by a private form of the archival key for the messaging system.

7. A messaging data processing system comprising:
a messaging system configured for coupling to a plurality of messaging clients;
a message archive coupled to the messaging system;
a plurality of bulk data keys accessible by the messaging system for decrypting archived messages in the message archive; and,
message archival assurance logic comprising program code enabled to determine whether a received encrypted message is decryptable using one of the bulk data keys and to archive and forward the encrypted message to a designated one of the messaging clients only if the encrypted message is decryptable using one of a the bulk keys and to otherwise discard the encrypted message.

8. A computer program product comprising a computer usable medium having computer usable program code for message archival assurance in a messaging system, the computer program product including:
computer usable program code for receiving an encrypted message designated for receipt by a messaging client;
computer usable program code for determining whether the encrypted message is decryptable using one of a set of a bulk keys accessible by the messaging system; and,
computer usable program code for archiving and forwarding the encrypted message to the messaging client only if the encrypted message is decryptable using one of a set of bulk keys accessible by the messaging system and otherwise discarding the encrypted message.

9. The computer program product of claim 8, further comprising computer usable program code for obtaining a key from the messaging client able to decrypt the encrypted message, adding the obtained key to a set of bulk keys for the messaging system, and archiving and forwarding the encrypted message to the messaging client, in response to determining that the encrypted message is not decryptable using an archival key accessible by the messaging system.

10. The computer program product of claim 9, wherein the computer usable program code for obtaining a key from the messaging client able to decrypt the encrypted message, comprises:
computer usable program code for forwarding an encrypted set of bulk keys associated with the encrypted message to the messaging client;
computer usable program code for receiving a decrypted one of the set of bulk keys associated with the encrypted message from the messaging client; and,
computer usable program code for adding the decrypted one of the set of bulk keys to the bulk keys accessible by the messaging system.

11. The computer program product of claim 10, wherein the computer usable program code for receiving a decrypted one of the set of bulk keys associated with the encrypted message from the messaging client, comprises:
computer usable program code for receiving a re-encrypted one of the set of bulk keys using a public form of an archival key for the messaging system; and,
computer usable program code for decrypting the re-encrypted one of the set of bulk keys using a private form of the archival key for the messaging system.

12. The computer program product of claim 11, further comprising:
computer usable program code for decrypting the encrypted message to produce a decrypted message; and,
computer usable program code for validating the decrypted message.

13. The computer program product of claim 9, wherein the computer usable program code for obtaining a key from the messaging client able to decrypt the encrypted message, comprises:
computer usable program code for receiving a selected bulk data key encrypted with a public form of an archival key for the messaging system; and,
computer usable program code for verifying that the encrypted selected bulk data key is marked as decryptable by a private form of the archival key for the messaging system.
